(19) United States
(12) Patent Application Publication
(10) Pub. No.: US 2010/0147200 A1
(43) Pub. Date: Jun. 17, 2010

(54) TABLE ASSEMBLY AND ACCESSORIES

(76) Inventor: Nicholas Polidoros, Mitcham (AU)

Correspondence Address: FROST BROWN TODD, LLC, 2200 PNC CENTER, 201 E. FIFTH STREET, CINCINNATI, OH, 45202, US

(21) Appl. No.: 12/377,096

(22) PCT Filed: May 3, 2007
(86) PCT No.: PCT/AU07/00589

§ 371 Date: Feb. 10, 2009

(51) Int. Cl. A47B 3/12; A47B 3/06; A47B 13/00; F16M 11/22

(52) U.S. Cl. 108/157.16; 108/157.17; 108/157.18; 248/167

(57) ABSTRACT

A table assembly (10), including a removable table top (12) having respective generally flat main surfaces (14, 16), and a supporting structure (18) for the table top (12), the supporting structure (18) including at least two frames (20) each having two upright legs (22) connected by at least one substantially horizontal member (24, 26), whereby the table top (12) rests on the upright legs (22). The frames (20) are mutually articulated about a vertical axis (32) by coupling the horizontal members (24, 26) at a position intermediate their respective ends (34, 36), such that the frames (20) pivot about the vertical axis (32) with respect to each other between an expanded position for supporting the table top (12) and a collapsed position for storage. In some forms of the invention, positive engagement between the table top and the supporting structure stabilise the supporting structure in the expanded position and prevents accidental collapsing of the table assembly.

### FIELD OF THE INVENTION

The present invention relates to table assemblies, particularly those that can be easily assembled for use and disassembled for storage. The table assemblies find particular application in a function or hospitality environment. The present invention also extends to accessories, particularly elevation stands for supporting an object for display on a table surface.

### BACKGROUND OF THE INVENTION

There are many situations, particularly in the function or hospitality environment, where a large number of tables are required to be temporarily set up for use and then packed away for storage. There is a requirement to be able to do this as quickly as possible with a minimum number of staff.

The traditional tables used in these situations are known as trestle tables. Trestle tables have a flat table top with depending legs that are permanently attached to the bottom surface of the table top. The legs are pivotable and when folded lie flat against the bottom surface so that the trestle tables can be stacked together when not in use. One of the main problems with trestle tables is that they can accidentally fold when knocked from one end. However, providing complicated means for locking the legs contributes substantially to set up and disassembly time.

Another problem with trestle tables is that their appearance is quite unattractive in formal or professional settings. It is therefore standard practice to drape the tables with table cloths. This of course adds to the time required to set up a room full of tables and to clear the room. Additional cost is incurred for laundering the table cloths.

It is therefore an object of the present invention to provide an improved table assembly that alleviates some of the problems with current tables for this purpose and achieves a balance between efficiency of set up and disassembly time, stability and appearance.

### SUMMARY OF THE INVENTION

According to a first aspect of the invention, there is provided a table assembly, including:
a removable table top having respective generally flat main surfaces; and
at least two supporting structures for the table top, each supporting structure including:
   at least two frames each having two upright legs connected by at least one substantially horizontal member, whereby the table top rests on the upright legs, the frames being mutually articulated about a vertical axis by coupling the horizontal members at a position intermediate their respective ends, such that the frames pivot about the vertical axis with respect to each other between an expanded position for supporting the table top and a collapsed position for storage.

According to a second aspect of the invention, there is provided a table assembly, including:
a removable table top having respective generally flat main surfaces; and
a supporting structure for the table top, the supporting structure including at least two frames each having two upright legs connected by at least one substantially horizontal member, whereby the table top rests on the upright legs;
wherein the frames are mutually articulated about a vertical axis by coupling the horizontal members at a position intermediate their respective ends, such that the frames pivot about the vertical axis with respect to each other between an expanded position for supporting the table top and a collapsed position for storage.

In the above first or second aspects, preferably the supporting structure does not extend laterally past the perimeter of the main surfaces of the table top. Either main surface of the table top can be the upper surface and preferably the main surfaces have different finishes such that the appearance of the table can be changed by flipping the table top.

According to a third aspect of the invention, there is provided a table assembly, including:
a removable table top having respective generally flat main surfaces; and
at least one supporting structure for the table top, the supporting structure including at least two frames each having two upright legs connected by at least one substantially horizontal member;
wherein the frames are mutually articulated about a vertical axis by coupling the horizontal members at a position intermediate their respective ends, such that the frames pivot about the vertical axis with respect to each other between an expanded position for supporting the table top and a collapsed position for storage, and wherein the table top includes at least four recesses provided in at least one surface of the table top for engagement by the upright legs to stabilise the supporting structure in the expanded position.

In the third aspect, preferably the supporting structure does not extend laterally past the perimeter of the main surfaces of the table top. Fixtures may be provided that house the recesses. The fixtures are preferably recessed into a main surface, such that the fixtures are flush with the main surface of the table top. Four fixtures may be provided and arranged to form a rectangle.

According to a fourth aspect of the invention, there is provided a table assembly, including:
a removable table top having respective generally flat main surfaces; and
at least one supporting structure for the table top, the supporting structure including at least two frames each having two upright legs connected by at least one substantially horizontal member;
wherein the frames are articulated about a vertical axis by coupling the horizontal members at a position intermediate their respective ends, such that the frames pivot about the vertical axis with respect to each other between an expanded position for supporting the table top and a collapsed position for storage, and wherein each upright leg includes a seat on which the table top rests thereby stabilising the supporting structure in the expanded position.

In the fourth aspect, preferably the supporting structure does not extend laterally past the perimeter of the main surfaces. Advantageously, the edges of table top engage the seat. Alternatively, the corners of the table top engage the seat. The upper end of the upright legs preferably has a corner removed to provide the seat. It is preferably that the table top is square and the supporting structure has two frames, such that one upright leg engages each edge of the table top.

In each of the aforesaid aspects of the invention, the table top is advantageously rectangular, although it will be appreciated that it may be any shape, such as circular. The upright legs and horizontal members may have a circular cross-section or a rectangular cross-section. Alternatively, the upright legs have a tubular cross-section and the horizontal members have a rectangular cross-section.

In each of the aforesaid aspects of the invention, it is preferable that the frames include at least one horizontal member adjacent the top of the upright legs. However, the frames may include two horizontal members adjacent respective ends of the upright legs. In this embodiment, the supporting structures can be positioned with either of the respective ends of the upright legs engaged with the ground. A vertical pin may be used to couple the horizontal member of one frame to the horizontal member of another frame. When two horizontal members are provided, respective vertical pins can couple the upper and lower horizontal members of one frame to those of another frame. A vertical member may extend between the upper and lower pins to provide stability to the supporting structure. A projection may be provided on one horizontal member to limit the angular expansion of the supporting structure.

According to a fifth aspect of the present invention, there is provided an elevation stand for supporting an object for display on a table surface, the stand including:

at least two frames each having two upright legs connected by at least one substantially horizontal member, whereby the object rests on the upright legs or on the substantially horizontal member;

wherein the frames are mutually articulated about a vertical axis by coupling the horizontal members at a position intermediate their respective ends, such that the frames pivot about the vertical axis with respect to each other between an expanded position for supporting the object and a collapsed position for storage.

The upright legs may be constructed in at least two longitudinal sections that clamped together to retain an end of a horizontal member between two sections.

Preferably, the longitudinal sections each include an internal thread and the end of the horizontal members include an aperture, whereby a threaded connector is inserted through the aperture and into the internal threads of the longitudinal sections which are tightened to clamp the horizontal member between two sections.

A vertical pin may be used to couple the horizontal member of one frame to the horizontal member of another frame. Preferably, the vertical pin is threaded and is received in an internally threaded stopping member that clamps against the lower horizontal member to prevent movement of the frames.

According to another aspect of the present invention, there is provided a set comprising a table assembly according to any of the first to fourth aspects of the invention and one or more elevation stands according to the fifth aspect of the invention.

### BRIEF DESCRIPTION OF THE DRAWINGS

The invention will now be described, by way of example only, with reference to the accompanying drawings, in which:

FIG. 1 is a perspective view of a table assembly according to a first aspect of the invention;

FIG. 2 is a perspective view of a table assembly according to a second aspect of the invention;

FIG. 3 is a perspective view of a table assembly according to a third aspect of the invention;

FIG. 4 is a perspective view of the table assembly of FIG. 3 with the supporting structure in the collapsed position;

FIG. 5 is a fragmentary cross-sectional view of the table assembly of FIGS. 3 and 4;

FIG. 6 is a perspective view of a table assembly according to a fourth aspect of the invention;

FIG. 7 is a fragmentary cross-sectional view of a table assembly of FIG. 6;

FIG. 8 is a partial perspective view of the table assembly of FIG. 6;

FIG. 9 is a perspective view of a table assembly according to an embodiment of the invention, with the table top partially removed;

FIG. 10 is a perspective view similar to FIG. 9, with the table top in the assembled position;

FIG. 11 is a perspective view of an elevation stand according to an aspect of the present invention;

FIG. 12 is a perspective view of three different elevation stands according to an aspect of the present invention; and

FIG. 13 shows two views of the assembly of the upright legs of the elevation stands according to an embodiment of this aspect of the invention.

### DETAILED DESCRIPTION OF THE EMBODIMENTS

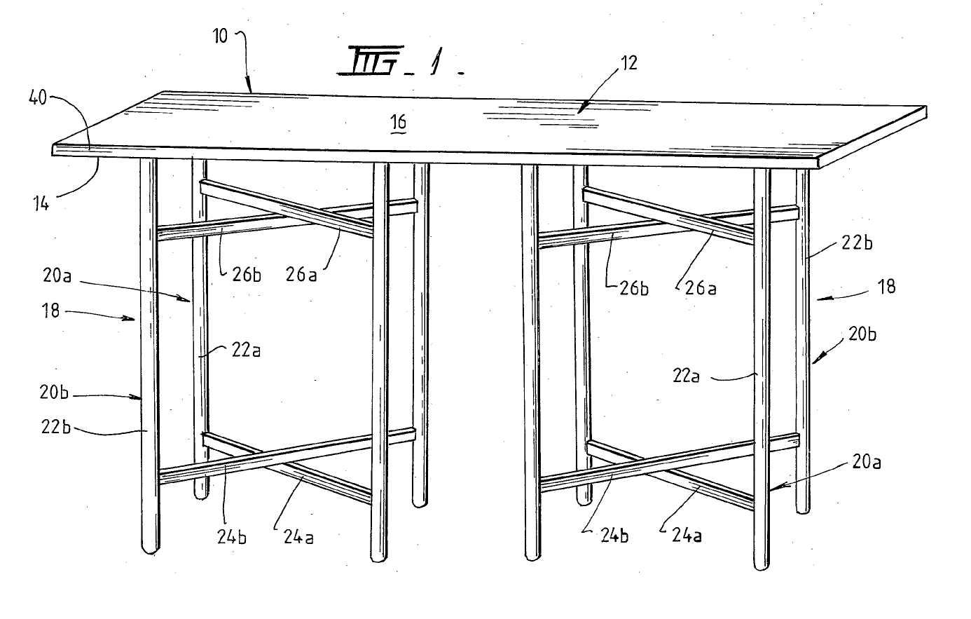

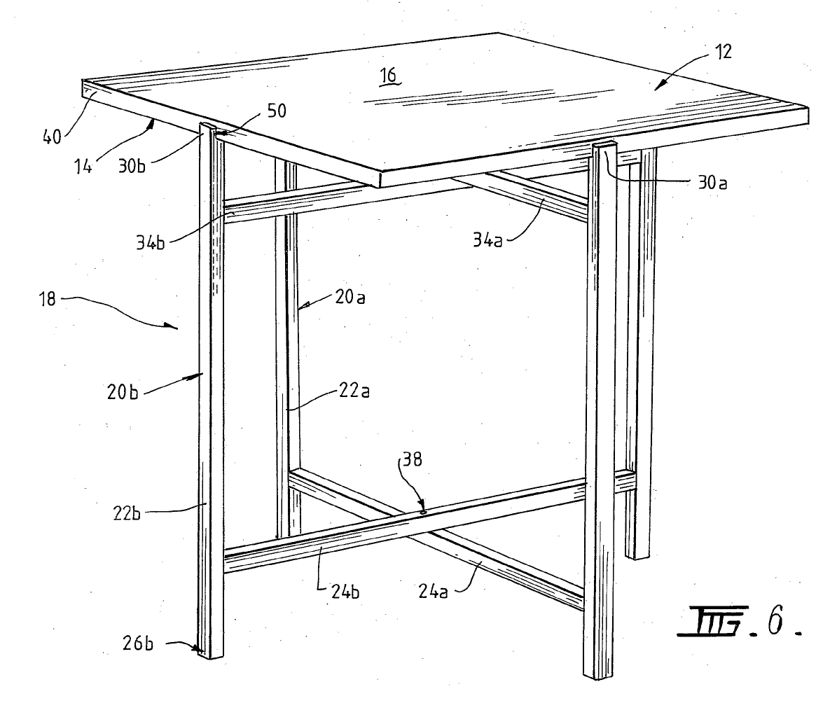

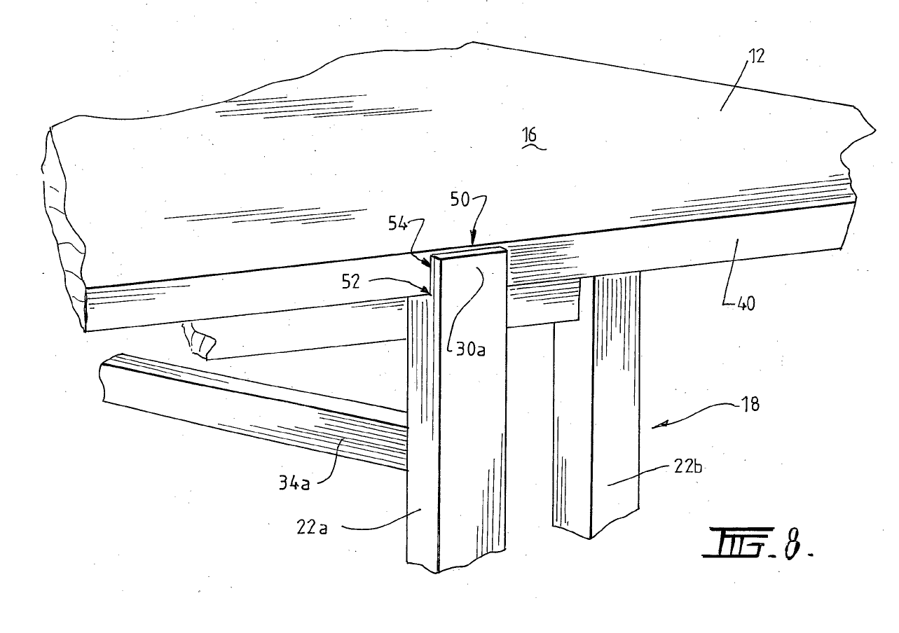

A number of different embodiments of the invention can be found in FIGS. 1 to 10. Like numerals have been used where similar features are present in the drawings.

A table assembly 10 is provided that includes a removable table top 12 having respective generally flat main surfaces 14, 16. In the embodiments shown in FIGS. 1, 2, 6-10, the main surfaces 14, 16 may have different finishes such that the appearance of the table assembly 10 can be changed by flipping the table top 12. In another form, table top 12 may be glass or otherwise transparent. A supporting structure 18 is used to support the table top 12 when in the assembled position, as best shown in FIGS. 1, 2 and 6. As shown in FIG. 1, two supporting structures 18 may be used to support a single table top 12 of greater length.

The supporting structure 18 includes at least two frames 20a, 20b, each frame 20 has two upright legs 22 connected by horizontal members 24, 26 adjacent the respective ends 28, 30 of the upright legs 22. It can be seen from the Figures, the ends 28 engage the ground and the table top 12 rests on the ends 30 of upright legs 22. However, it will be appreciated that the supporting structures 18 shown are symmetrical about a horizontal central plane and therefore may be orientated with either ends 28 or ends 30 engaged with the ground. This allows the set up of the table assemblies to be accomplished quickly, as ensuring correct orientation of the support structures 18 is not required.

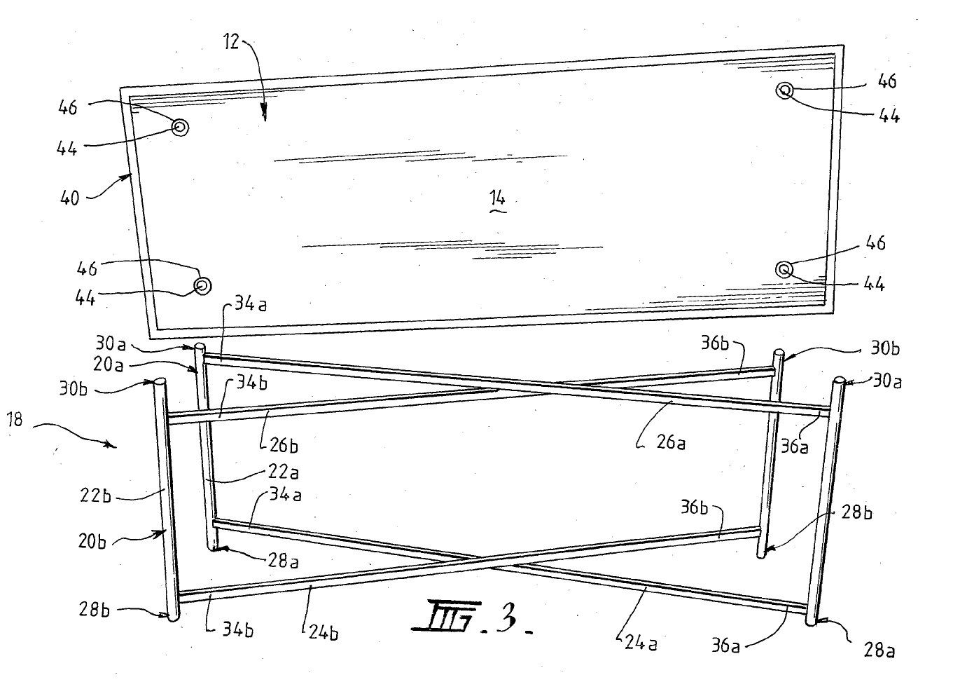

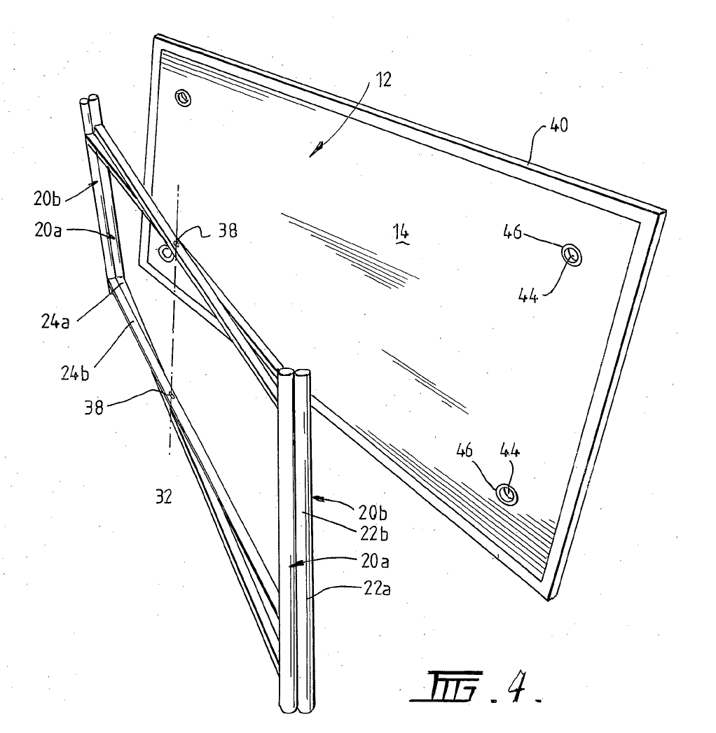

The frames 20a, 20b are mutually articulated about a vertical axis 32, best shown in FIG. 4. The two frames 20a, 20b are coupled, at a position intermediate the respective ends 34, 36 of the horizontal members 24, 26, by vertical pins 38. As can be seen in FIGS. 3 and 4, the frames 20a, 20b pivot about the vertical axis 32 with respect to each other between an expanded position (FIG. 3) for supporting the table top 12 and a collapsed position (FIG. 4) for storage.

The table tops 12 are removable, such that they can be stacked separately to the supporting structures 18. The table assemblies 10 can be stored on trolleys, the supporting structures 18 hang on racks, with the horizontal members 26 hooking over arms on the trolley so as to be suspended.

In the embodiments shown in FIGS. 1 to 5, the supporting structure 18 does not extend past the perimeter 40 of the main surfaces 14, 16 and is therefore neatly hidden beneath the table top 12.

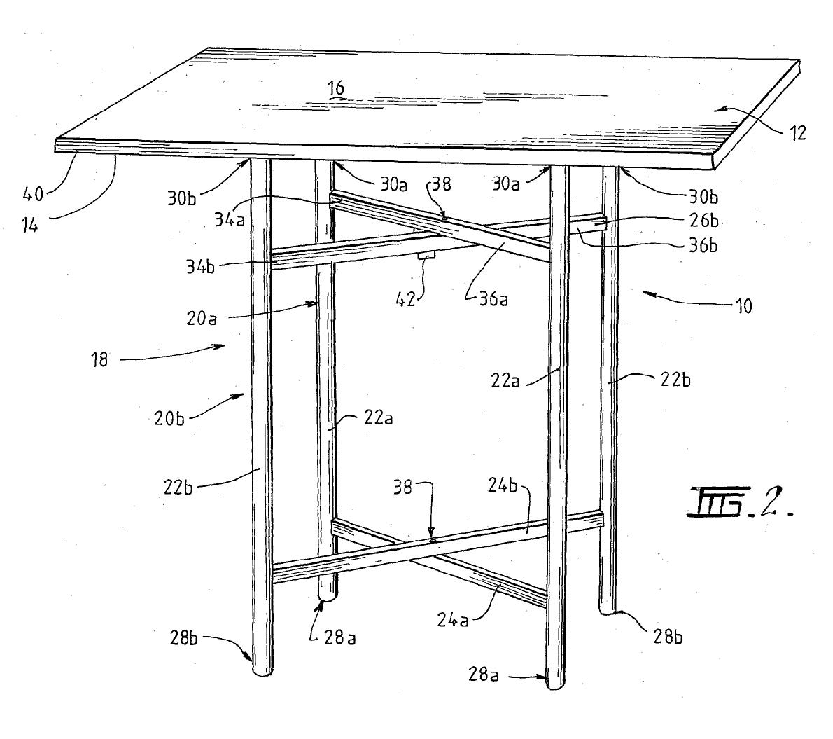

As can be seen from the different embodiments shown in the drawings, the supporting structures may have relatively short horizontal members 24, 26 as shown in FIGS. 1 and 2 creating a substantially square arrangement of the upright legs 22. In this case, two supporting structures 18 are used to support a long table top 12. Alternatively, the horizontal members 24, 26 may be long, as shown in FIG. 3, such that one supporting structure 18 is used to support a long table top 12. For ease of manufacture and aesthetic reasons, the upright legs 22 in this embodiment typically have a circular cross-section and may be made from tubular steel. The horizontal members 24, 26 typically have a rectangular cross-section and may be box section steel.

To set up the table assembly 10 shown in FIG. 2, the supporting structure 12 is stored in the collapsed position and is lifted off the trolley and set on the ground with ends 28 of the upright legs 22 on the ground. One of the frames 20a is then pivoted with respect to the other frame 20b, until a projection 42 on horizontal member 26a abuts against horizontal member 26b to limit the angular expansion of the supporting structure 18. The table top 12 is then lifted and sat on top of the ends 30 of the upright legs 22.

In the embodiment shown in FIGS. 3 to 5, the table top 12 includes four recesses 44 contained within fixtures 46. The fixtures are preferably stainless steel and are inserted into pre-drilled hollows 48 in main surface 14 so as to be flush. The ends 30 of the upright legs 22 positively engage in the recesses 44 to stabilise the supporting structure 18 in the expanded position. The table cannot be accidentally knocked over, as the table top 12 must be lifted to disengage the ends 30 of the upright legs 22.

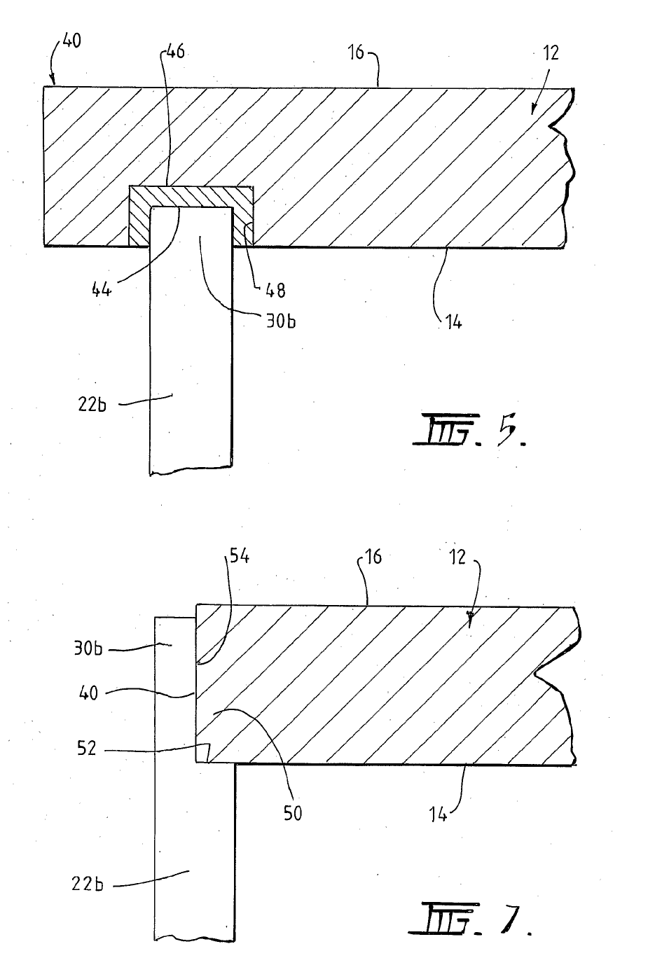

In the embodiment shown in FIGS. 6 to 8, each upright leg 22 includes a seat 50 in end 30. The upright legs 22 have a rectangular cross-section and a corner is cut away to create a horizontal surface 52 and a vertical surface 54. The table top 12 rests on the seat 50, with the main surface 14 engaged with horizontal surface 52 and the perimeter, or edge, 40 of the table top 12 engaging with the vertical surface 54, thereby stabilising the supporting structure 18 in the expanded position. Similar to above, the table cannot be knocked over accidentally, as the table top 12 must be lifted to disengage the ends 30 of the upright legs 22.

The advantage of the embodiment shown in FIGS. 6 to 8 is that the supporting structure 18 can be expanded by pivoting the frames 20a, 20b to where the horizontal members 24, 26 lie perpendicular to one another. The table top 12 can then simply be dropped into place on the seats 50. The table top 12 can have different finishes on the main surfaces 14, 16 to create two different aesthetically appealing looks. The different finishes may be two different colours, so that all tables in a room are the same colour or may alternate.

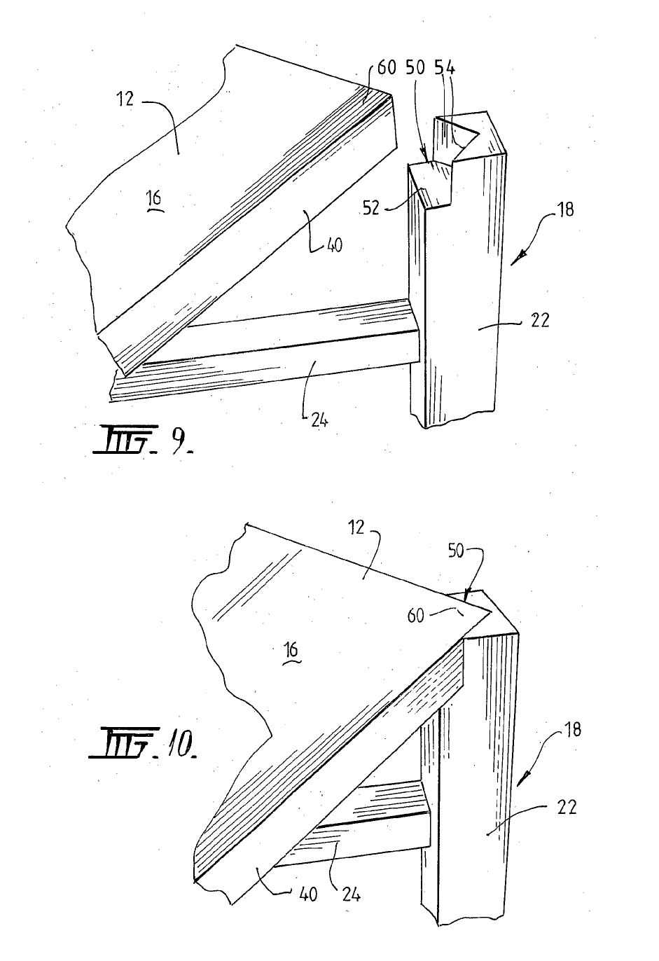

A variation of the embodiment shown in FIGS. 6 to 8 is shown in FIGS. 9 and 10. The upright legs 22 have a cut away angle to create the seat 50 with one horizontal surface 52 and two vertical surfaces 54. The corners 60 of the table top 12 engage in the seats 50 to stabilise the supporting structure 18 in the expanded position.

A table assembly 10 made according to any of the aspects of the present invention is easily and quickly assembled by a single person. The simplicity of the appearance makes it suitable for any function, without the table top being draped. In some forms of the invention positive engagement between the supporting structure and table top prevents accidental collapsing of the table assembly, whilst providing easy and simple engagement and disengagement for setting up and storage.

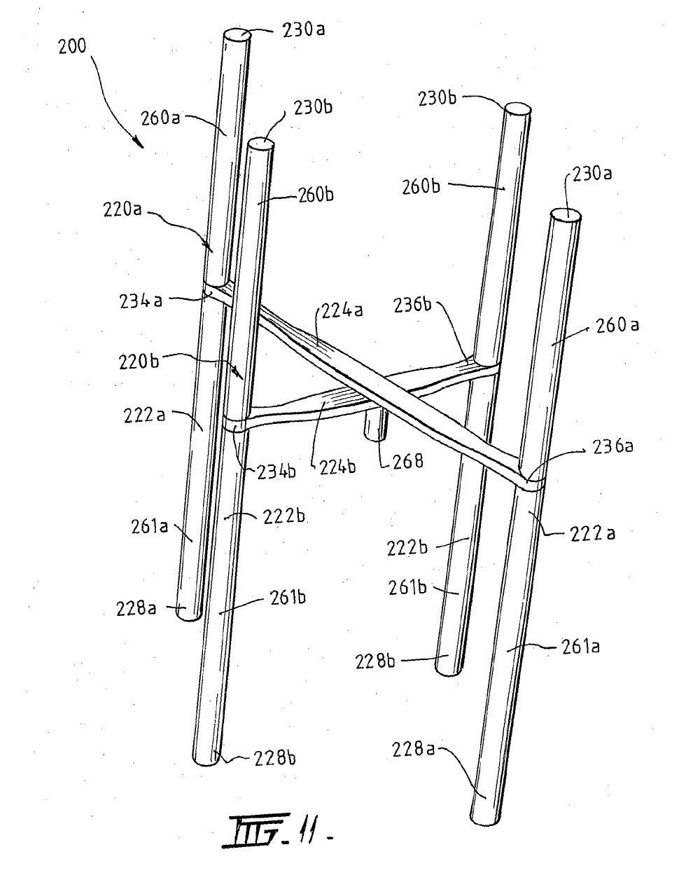

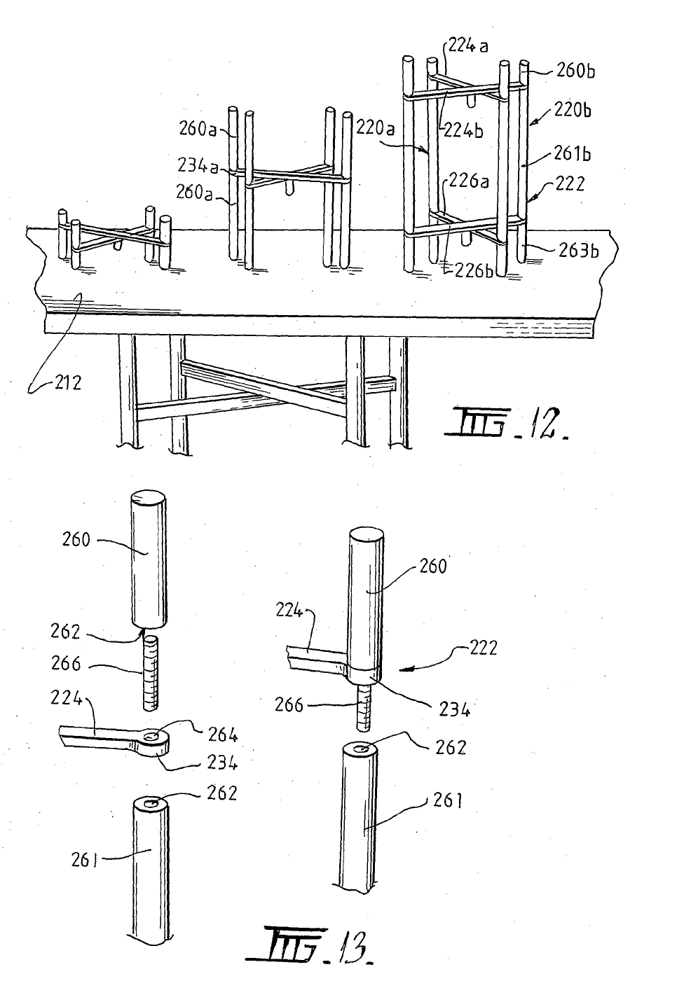

FIGS. 11 to 13 show another aspect of the invention, being elevation stands 200. Elevation stands 200 are used for supporting an object for display on a table surface 212, such as plates, bowls etc (not shown) for serving food. The table surface may be part of a table assembly according to one of the embodiments shown in FIGS. 1 to 11. The table assemblies and one or more elevation stands 200 may form a matching set for functions, as shown in FIG. 12.

The elevation stands 200 include at least two frames 220a, 220b each having two upright legs 222 connected by at least one substantially horizontal member 224, whereby the object rests on the end 230 of the upright legs or on the substantially horizontal members 224;

The frames 220a, 220b are mutually articulated about a vertical axis by coupling the horizontal members at a position intermediate their respective ends 234, 236, such that the frames 220 pivot about the vertical axis with respect to each other between an expanded position for supporting the object and a collapsed position for storage.

As can best be seen in FIG. 13, the upright legs 222 may be constructed in at least two longitudinal sections 260, 261 that clamped together to retain an end 234 of a horizontal member 224 between two sections 260, 261. As can be seen in FIG. 12, the frames 220 may include two horizontal members 224, 226. In this embodiment there is included three longitudinal sections 260, 261, 263 to clamp the horizontal member 224 between sections 260 and 261 and to clamp the horizontal member 226 between sections 261 and 263.

The longitudinal sections 260, 261 each include an internal thread 262 and the end of the horizontal members 224 include an aperture 264, whereby a threaded connector 266 is inserted through the aperture and into the internal threads 262 of the longitudinal sections 260, 261, which are tightened, as illustrated in FIG. 13 to clamp the horizontal member 224 between two sections 260, 261.

A vertical pin (not shown) may be used to couple the horizontal member 224a of one frame 220a to the horizontal member 224b of another frame 220b. This is best illustrated in FIG. 11. Preferably, the vertical pin is threaded and is received in an internally threaded stopping member 268 that clamps against the lower horizontal member 224b to prevent movement of the frames 220.

1. A table assembly, including:
a removable table top having respective generally flat main surfaces;
at least two supporting structures for the table top, each supporting structure including:
at least two frames each having two upright legs connected by at least one substantially horizontal member, whereby the table top rests on the upright legs, the frames being mutually articulated about a vertical axis by coupling the horizontal members at a position intermediate their respective ends, such that the frames pivot about the vertical axis with respect to each other between an expanded position for supporting the table top and a collapsed position for storage.

2. A table assembly according to claim 1, wherein the supporting structure does not extend laterally past the perimeter of the main surfaces.

3. (canceled)

4. (canceled)

5. (canceled)

6. (canceled)

7. (canceled)

8. (canceled)

9. A table assembly according to claim 1, wherein the frames include one horizontal member adjacent the top of the upright legs.

10. A table assembly according to claim 1, wherein the frames include two horizontal members adjacent respective ends of the upright legs.

11. (canceled)

12. A table assembly according to claim 1, wherein a vertical pin couples a horizontal member of one frame to a horizontal member of another frame.

13. A table assembly according to claim 12, wherein respective upper and lower vertical pins couple the upper and lower horizontal members of one frame to the upper and lower horizontal members of another frame and whereby a vertical member extends between the upper and lower pins to provide stability to the supporting structure.

14. A table assembly according to claim 1, wherein a projection is provided on one horizontal member to limit the angular expansion of the supporting structure.

15. A table assembly, including:
a removable table top having respective generally flat main surfaces;
at least one supporting structure for the table top, the supporting structure including at least two frames each having two upright legs connected by at least one substantially horizontal member;
wherein the frames are mutually articulated about a vertical axis by coupling the horizontal members at a position intermediate their respective ends, such that the frames pivot about the vertical axis with respect to each other between an expanded position for supporting the table top and a collapsed position for storage, and wherein the table top includes at least four recesses provided in at least one surface of the table top for engagement by the upright legs to stabilise the supporting structure in the expanded position.

16. A table assembly according to claim 15, wherein the supporting structure does not extend laterally past the perimeter of the main surfaces.

17. (canceled)

18. (canceled)

19. (canceled)

20. (canceled)

21. (canceled)

22. (canceled)

23. (canceled)

24. A table assembly according to claim 15, wherein a vertical pin couples a horizontal member of one frame to a horizontal member of another frame.

25. A table assembly according to claim 24, wherein respective vertical pins couple upper and lower horizontal members of one frame to upper and lower horizontal members of another frame and whereby a vertical member extends between the upper and lower pins to provide stability to the supporting structure.

26. A table assembly according to claim 15, wherein a projection is provided on one horizontal member to limit the angular expansion of the supporting structure.

27. A table assembly according to claim 15, wherein fixtures are provided that house the recesses.

28. A table assembly according to claim 27, wherein the fixtures are recessed into a main surface, such that the fixtures are flush with the main surface of the table top.

29. A table assembly according to claim 27, wherein four fixtures are provided and are arranged to form a rectangle.

30. A table assembly, including:
a removable table top having respective generally flat main surfaces;
at least one supporting structure for the table top, the supporting structure including at least two frames each having two upright legs connected by at least one substantially horizontal member;
wherein the frames are articulated about a vertical axis by coupling the horizontal members at a position intermediate their respective ends, such that the frames pivot about the vertical axis with respect to each other between an expanded position for supporting the table top and a collapsed position for storage, and wherein each upright leg includes a seat on which the table top rests thereby stabilising the supporting structure in the expanded position.

31. (canceled)

32. (canceled)

33. (canceled)

34. (canceled)

35. (canceled)

36. (canceled)

37. (canceled)

38. (canceled)

39. (canceled)

40. A table assembly according to claim 30, wherein the edges of table top engage the seat.

41. A table assembly according to claim 30, wherein the upper end of the upright legs has a corner removed to provide the seat.

42. A table assembly according to claim 41, wherein the table top is square and the supporting structure has two frames, such that one upright leg engages each edge of the table top.

43. A table assembly according to claim 30, wherein the corners of the table top engage the seat.

44. An elevation stand for supporting an object for display on a table surface, the stand including:
at least two frames each having two upright legs connected by at least one substantially horizontal member, whereby the object rests on the upright legs or on the substantially horizontal member;
wherein the frames are mutually articulated about a vertical axis by coupling the horizontal members at a position intermediate their respective ends, such that the frames pivot about the vertical axis with respect to each other between an expanded position for supporting the object and a collapsed position for storage.

45. An elevation stand according to claim 44, wherein the upright legs are constructed in at least two longitudinal sections that clamped together to retain an end of a horizontal member between two sections.

46. An elevation stand according to claim 45, wherein the longitudinal sections each include an internal thread and the end of the horizontal members include an aperture, whereby a threaded connector is inserted through the aperture and into the internal threads of the longitudinal sections which are tightened to clamp the horizontal member between two sections.

47. An elevation stand according to claim 44, wherein a vertical pin couples the horizontal member of one frame to the horizontal member of another frame.

48. An elevation stand according to claim 47, wherein the vertical pin is threaded and is received in an internally threaded stopping member that clamps against the lower horizontal member to prevent movement of the frames.

49. (canceled)
